(19) United States
(12) Patent Application Publication
(10) Pub. No.: US 2004/0190465 A1
(43) Pub. Date: Sep. 30, 2004

(54) Delaying an exchange of information packets associated with an embedded controller

(76) Inventor: Shailendra M. Padhye, Hillsboro, OR (US)

Correspondence Address: BUCKLEY, MASCHOFF, TALWALKAR LLC, 5 ELM STREET, NEW CANAAN, CT, 06840, US

(21) Appl. No.: 10/402,354

(22) Filed: Mar. 28, 2003

(51) Int. Cl. H04L 5/22

(52) U.S. Cl. 370/299

(57) ABSTRACT

According to some embodiments, an exchange of information packets associated with an embedded controller is delayed.

### BACKGROUND

Different types of information can be exchanged through a communication network. Consider, for example, FIG. 1 illustrating a known network system 100 in which a server 110 exchanges information with remote devices 120, such as Personal Computers (PCs), via a communication network 130, such as a Local Area Network (LAN). Moreover, the server 110 may include a network controller 112 to transmit and receive information packets via the communication network 130.

One type of information that could be exchanged through the communication network 130 is Operating System (OS) information. For example, packets of OS information might be exchanged between the network controller 112 and an OS application client 122 executing on a remote device 120.

Another type of information that could be exchanged through the communication network 130 is network management information. For example, packets of network management information might be exchanged between the network controller 112 and a management client 124 executing on a remote device 120. The network management information packets may comprise, for example, Total Cost of Ownership (TCO) information packets that enable remote access to server management features over a LAN.

Thus, the network controller 112 may need to process both OS and TCO information packets. Moreover, multiple OS application clients 122 and management clients 124 might exchange information packets with the network controller 112. To store information packets that have been received from remote devices 120 (e.g., OS and TCO information packets that have not yet been processed), the network controller 112 may use a Receive (Rx) First-In, First-Out (FIFO) structure 114. As illustrated in FIG. 1, both OS and TCO information packets are stored in the Rx FIFO structure 114. A separate Transmit (Tx) FIFO structure (not shown in FIG. 1) could be used to store OS and TCO information packets that will be transmitted from the network controller 112. In other cases, a single FIFO structure could store both Rx and Tx information packets.

Several problems may arise, however, when OS and TCO information packets are both stored in a FIFO structure. In particular, OS and TCO information packets may be processed at different rates. For example, the network controller 112 might process TCO information packets via an internal interface with an embedded controller. The interface with the embedded controller, however, might be significantly slower than another interface that is used to process OS information packets (e.g., an interface between the network controller 112 and an OS network stack).

As a result, when a large number of TCO information packets are stored in the Rx FIFO structure 114 ahead of one or more OS information packets, the OS network stack might not receive the OS information packets for an extended period of time. Likewise, when a large number of TCO information packets to be transmitted are in a Tx FIFO structure ahead of one or more OS information packets, the OS information packets might not be transmitted for an extended period of time. Note that similar problems may arise with other types of information packets.

Eventually, the inability to process OS information packets in a timely fashion might cause the OS network driver to lock-up (perhaps triggering an entire OS crash and/or halting all network communication). In addition, such a deadlock condition could cause a remote OS application client 122 to abort or terminate (e.g., because it did not receive information from the server 200 within a predetermined time-out period).

Moreover, the server 200 may be susceptible to a Denial of Service (DoS) attack. For example, a remote device 120 could continuously construct and transmit a large number of counterfeit TCO information packets to the server 200, such as by sending User Datagram Protocol (UDP) information packets to a port associated with TCO information (e.g., port “623d”). Such a flood of counterfeit TCO information packets may prevent the server from processing legitimate OS (and TCO) information packets for an extended period of time—resulting in the deadlock and time-out problems described above.

### BRIEF DESCRIPTION OF THE DRAWINGS

FIG. 1 is a block diagram of a known network system.

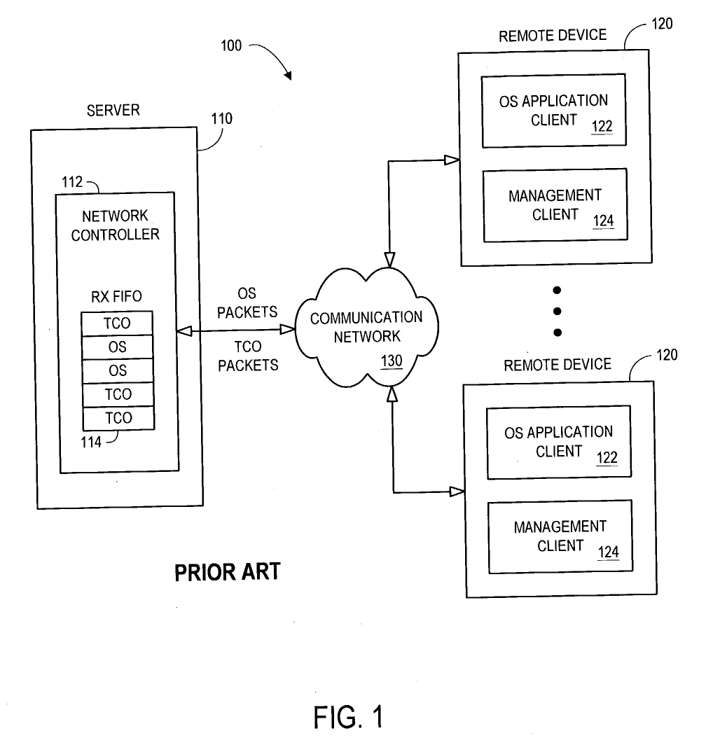

FIG. 2 is a block diagram of a server according to some embodiments.

FIG. 3 is a block diagram of an embedded controller according to some embodiments.

FIG. 4 is a flow chart of a method of transmitting information packets according to some embodiments.

FIG. 5 is a flow chart of a method of receiving information packet according to some embodiments.

FIG. 6 is a flow chart of a method of transmitting TCO information packets according to some embodiments.

FIG. 7 is a flow chart of a method of receiving TCO information packets according to some embodiments.

### DETAILED DESCRIPTION

Some embodiments described here are associated with a communication “network” and/or “network” devices. As used herein, the term “network” may refer to, for example, a network associated with the Fast Ethernet LAN transmission standard 802.3-2002® published by the Institute of Electrical and Electronics Engineers (IEEE).

Moreover, some embodiments are associated with “packets” of information. As used herein, the term “packet” may refer to, for example, Transmission Control Protocol (TCP)/UDP Internet Protocol (IP) information packets.

Server

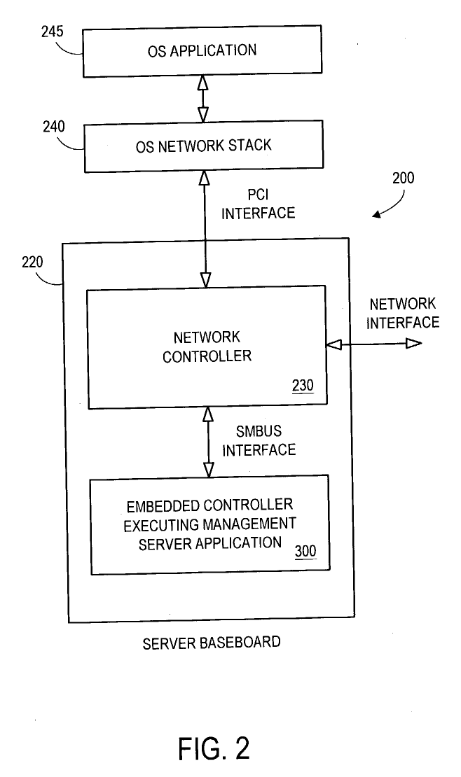

FIG. 2 is a block diagram of a server 200 that includes a server baseboard 220 with a network controller 230. The network controller 230 may be, for example, an Ethernet controller that exchanges information with remote devices via a communication network. One example of a network controller 230 is the INTEL® 82559 10/100 Mega-bits per second (Mbps) Fast Ethernet controller that might be used in a Network Interface Card (NIC), a PC LAN On Motherboard (LOM) design, and/or other networking system products.

One type of information that might be exchanged by the network controller 230 is OS or application information. The OS information may be exchanged, for example, between an OS network stack 240 in the server 200 (e.g., associated with a network driver) and an OS application client executing on a remote device. In particular, the network controller 230 may exchange OS information packets with the OS network stack 240 via a Peripheral Component Interconnect (PCI) interface as defined by the PCI Special Interest Group (SIG) in “PCI Local Bus Specification Revision 2.2” (Dec. 18, 1998). In this case, information might be exchanged, for example, at a rate of 132 Mega-Bytes per second (MBps). The OS network stack 240 may in turn exchange information with one or more OS applications 245.

Another type of information that might be exchanged by the network controller 230 is network or server management information, such as TCO information packets that enable remote access to server management features over a LAN. The network management information packets may be exchanged, for example, between an embedded controller 300 in the server 200 (e.g., executing a management server application) and a management client executing on a remote device. In particular, the network controller 230 may exchange the TCO information packets with the embedded controller 300 via a System Management Bus (SMBUS) interface as defined by the Smart Battery System (SBS) Implementers Forum in “System Management Bus Specification Version 2.0” (Aug. 3, 2000). In this case, information may be exchanged, for example, at the rate of 50 Kilo-bits per second (Kbps). Note that information might be exchanged via the SMBUS interface at a significantly slower rate as compared to the PCI interface.

The network controller 230 may need to process both OS and TCO information packets. Moreover, multiple OS application clients and management clients (i.e., executing on remote devices) may be exchanging information packets with the network controller. To store information packets that are being exchanged with remote devices (e.g., OS and TCO information packets that have been received but not yet processed), the network controller 230 may incorporate a FIFO structure. For example, the network controller 230 may include a transmit FIFO queue and a receive FIFO queue, each queue being able to store 3 Kilo-bytes (Kbytes) of information.

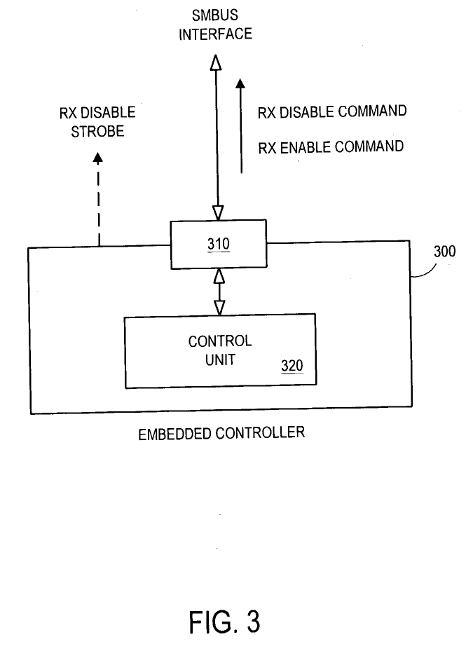

A detailed description of the embedded controller 300 will now be provided with respect to FIG. 3.

Embedded Controller

FIG. 3 is a block diagram of an embedded controller 300 according to some embodiments. The embedded controller 300 includes a communication port 310 that may be used to exchange information packets with, for example, the network controller 230 (e.g., via an SMBUS interface).

The information packets may comprise, for example, TCO information packets (or any other type of information packets) that are processed by a control unit 320. The control unit 320 may include hardware, software (including firmware), or a combination of hardware and software adapted to process information packets in accordance with embodiments of the present invention.

The embedded controller 300 may also exchange one or more control commands or signals with the network controller 230. For example, the embedded controller 300 might transmit an Rx disable command to the network controller 230 via the SMBUS interface. As a result, the network controller 230 may stop sending information packets to the embedded controller 300. Note that the network controller 230 could still receive the information packets from remote devices—even if those packets are destined for the embedded controller 300 (e.g., the network controller 230 might store those packets until it is allowed to send them to the embedded controller 300). Moreover, the embedded controller 300 might transmit an Rx enable command to the network controller 230 via the SMBUS interface (e.g., indicating that the network controller 230 should resume sending information packets to the embedded controller 300). According to another embodiment, an Rx disable strobe signal serves a similar purpose.

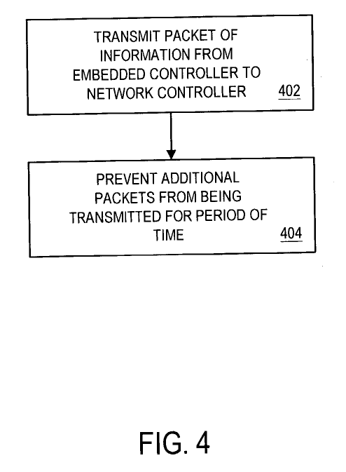

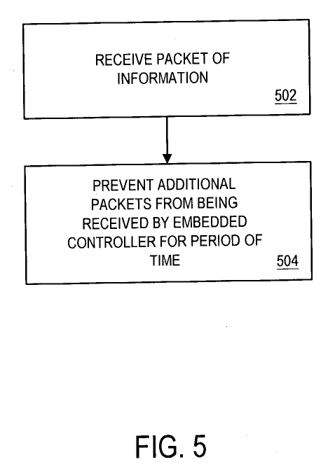

A detailed description of the operation of the control unit 320 will now be provided with respect to FIGS. 4 and 5.

Packet Transmission Method

FIG. 4 is a flow chart of a method of transmitting information packets according to some embodiments. The flow charts described herein do not necessarily imply a fixed order to the actions, and embodiments may be practiced in any order that is practicable. The method may be associated with, for example, the control unit 320 illustrated and described with respect to FIG. 3.

At 402, a packet of information is transmitted. For example, the control unit 320 may generate and transmit an information packet to the network controller 230 via an SMBUS interface (e.g., so that the network controller 230 will eventually forward the information packet to a management client executing on a remote device).

At 404, additional packets of information are prevented from being transmitted for a period of time. For example, the control unit 320 may store additional information packets unit a pre-determined period of time has elapsed (e.g., in a local FIFO structure). According to other embodiments, the control unit 320 instead delays the generation of additional information packets (e.g., and thus no local FIFO structure may be required).

Instead of delaying the transmission of additional packets for a pre-determined duration, the control unit 320 might wait until a pre-determined time before resuming the transmission of additional packets (e.g., until the start of a next cycle). Moreover, the delay might not be directly triggered by a transmission of an information packet. For example, a delay of a pre-determined duration could be inserted on a periodic basis (i.e., even if no TCO information packet has been transmitted).

According to some embodiments, the control unit 320 delays the transmission of additional packets every time a single information packet is transmitted to the network controller 230. According to other embodiments, however, the control unit 320 instead delays the transmission of additional packets only after a pre-determined number of packets have been transmitted (e.g., after five information packets have been transmitted over the SMBUS interface). Similarly, the control unit 320 could delay the transmission of additional packets after a pre-determined amount of information has been transmitted (e.g., after ten octets of information have been transmitted—regardless of how many packets were used to transmit the information). Moreover, any combination of the techniques could be provided.

Because the flow of information packets from the embedded controller 300 to the network controller 230 is throttled, some embodiments may help prevent information packets sent by the embedded controller 300 from overwhelming a transmit queue in the network controller 230.

Packet Receipt Method

FIG. 5 is a flow chart of a method of receiving information packet according to some embodiments. The method may be associated with, for example, the embedded controller 300 and/or the network controller 230. Note that this method might be performed along with the packet transmission method illustrated in FIG. 4 or might instead be implemented without that packet transmission method.

At 502, a packet of information is received. For example, the control unit 320 may receive an information packet from the network controller 230 via an SMBUS interface (e.g., a TCO information packet originating from a management client executing on a remote device).

At 504, additional packets of information are prevented from being received for a period of time. For example, the embedded controller 300 might transmit an Rx disable command to the network controller 230 via the SMBUS interface (e.g., so that the network controller 230 will stop sending information packets to the embedded controller 300). After a pre-determined period of time, the embedded controller 300 can then transmit an Rx enable command to the network controller 230 via the SMBUS interface (e.g., so that the network controller 230 will resume sending information packets to the embedded controller 300). According to another embodiment, the network controller 230 automatically resumes sending information packets to the embedded controller 300 after a predetermined period of time (e.g., and thus no Rx enable command is required). According to still another embodiment, the embedded controller 300 instead uses an Rx disable strobe signal to prevent the receipt of additional packets of information.

Instead of delaying the receipt of additional packets for a pre-determined period of time, the control unit 320 might wait until a pre-determined time (e.g., the start of a next cycle) before accepting additional packets. Moreover, the delay might not be directly triggered by a receipt of a information packet. For example, a delay of a pre-determined duration may be inserted on a periodic basis (i.e., even when no information packet has been received).

According to some embodiments, the control unit 320 delays the receipt of additional packets every time a single information packet is received from the network controller 230. According to other embodiments, however, the control unit 320 instead delays the receipt of additional packets only after a pre-determined number of information packets have been transmitted (e.g., after n information packets have been received via the SMBUS interface). Similarly, the control unit 320 could delay the receipt of additional packets after a pre-determined amount of information has been received (e.g., after m octets of information have been received). Moreover, any combination of techniques could be used. For example, the Rx disable command might be transmitted after n packets of m length have been received by the control unit 320.

Thus, the embedded controller 300 may monitor and control the receipt of information packets. According to another embodiment, the network controller 230 instead performs this function. For example, after a predetermined amount of information destined for the embedded controller 300 has been received, the network controller 230 might arrange for one or more remote devices and/or clients to stop sending information packets destined for the embedded controller 300.

Because the receipt of information packets is throttled, some embodiments may improve the performance of a network controller 230 and/or an embedded controller 300.

### EXAMPLE

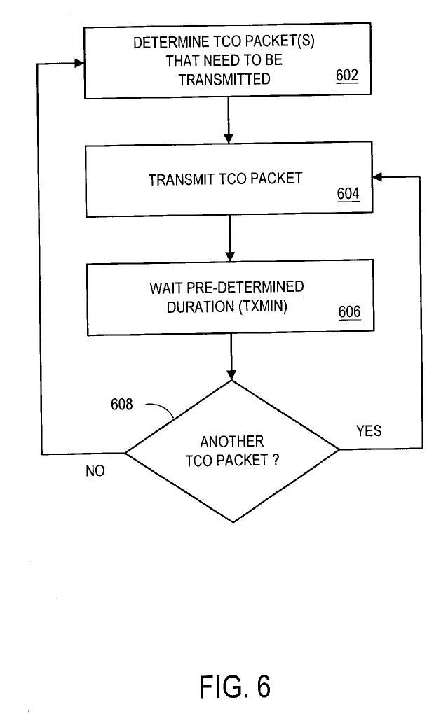

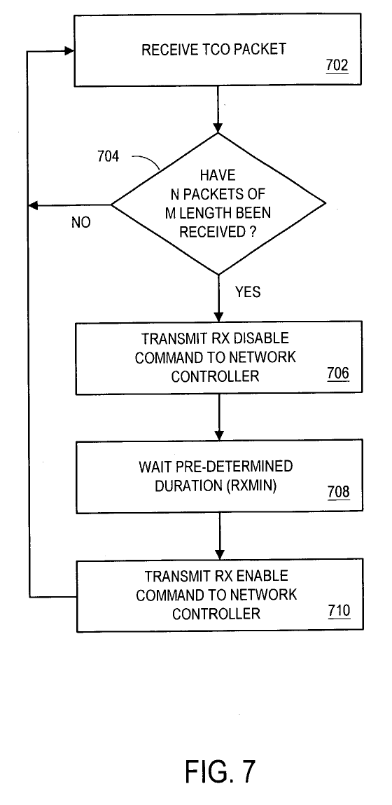

FIG. 6 is a flow chart of a method of transmitting TCO information packets according to some embodiments. The method may be associated with, for example, the control unit 320 illustrated and described with respect to FIG. 3. Although TCO information packets are used as an example in FIGS. 6 and 7, embodiments may be associated with any type of information packet.

At 602, it is determined that one or more TCO information packets need to be (or should be) transmitted. For example, a management server application executing in the embedded controller 300 may determine that a TCO information packet needs to be transmitted to a management client executing on a remote device.

At 604, the TCO information packet is transmitted. For example, the control unit 320 may transmit the TCO information packet to the network controller 230 via an SMBUS interface (so that the packet will be forwarded by the network controller 230 to the appropriate remote device).

At 606, the control unit 320 waits for a pre-determined duration (Tx_Min). If after the delay another TCO information packet needs to be transmitted at 608, the process continues at 604 (i.e., and an additional TCO information packet is transmitted). If no other TCO information packet currently needs to be transmitted at 608, the process continues at 602 (e.g., until additional TCO information packets need to be transmitted).

FIG. 7 is a flow chart of a method of receiving TCO information packets according to some embodiments. The method may be associated with, for example, the embedded controller 300 and/or the network controller 230.

At 702, a TCO information packet is received. For example, the control unit 320 may receive the TCO information packet from the network controller 230 via an SMBUS interface.

If n TCO information packets of m length have not yet been received at 704, the process continues at 702 (i.e., and any additional TCO information packets can be received without delay). If n TCO information packets of m length have been received at 704, an Rx disable command is sent to the network controller 230 via the SMBUS interface (e.g., to prevent the network controller 230 from sending additional TCO information packets to the embedded controller 300). The control unit 320 then waits for a pre-determined (Rx_Min) at 708. After the delay, an Rx enable command is sent to the network controller 230 via the SMBUS interface at 710 (e.g., so that the network controller 230 will resume sending TCO packets to the embedded controller 300), and the process continues at 702 (i.e., so that further TCO information packets can be received by the control unit 320). Note that an information packet count maintained by the control unit 320 (e.g., indicating how many packets of m length have been received) could also be reset at this time (e.g., reset to zero).

Additional Embodiments

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although embodiments have been described with respect to specific techniques that may be used to prevent network management information packets from being transmitted and/or received, other techniques could also be used. For example, the transmission and/or receipt of information might be throttled on an isochronous basis (e.g., only a predetermined amount of information might be allowed during a specific period).

Further, although software or hardware may have been described as performing particular functions, such functions could be performed using either software or hardware —or a combination of software and hardware (e.g., a medium may store instructions adapted to be executed by a processor to perform a method of facilitating an exchange of network management information).

The several embodiments described herein are solely for the purpose of illustration. Persons skilled in the art will recognize from this description other embodiments may be practiced with modifications and alterations limited only by the claims.

What is claimed is:

1. A method, comprising:
transmitting a packet of information from an embedded controller to a network controller; and
preventing additional packets of information from being transmitted for a period of time.

2. The method of claim 1, wherein said preventing is performed by the embedded controller.

3. The method of claim 1, wherein the packets are at least one of: (i) network management information packets, and (ii) total cost of ownership information packets.

4. The method of claim 1, wherein the packets are transmission control protocol/user datagram protocol Internet protocol packets.

5. The method of claim 1, wherein the embedded controller and the network controller are associated with a server baseboard.

6. The method of claim 1, wherein the embedded controller is to execute a management server application.

7. The method of claim 1, wherein the packet is transmitted to the network controller via a system management bus interface.

8. The method of claim 7, wherein the network controller comprises an Ethernet controller.

9. The method of claim 8, wherein the Ethernet controller is also to exchange information with an operating system network stack via a peripheral component interconnect interface.

10. The method of claim 1, wherein the period of time is a predetermined duration.

11. The method of claim 1, further comprising:
receiving a packet of network management information; and
preventing additional packets of network management information from being received for a period of time.

12. The method of claim 11, wherein said preventing receipt of additional packets is associated with at least one of: (i) a network controller Rx disable command transmitted from the embedded controller to the network controller, and (ii) a network controller Rx disable strobe.

13. The method of claim 11, wherein said preventing receipt of additional packets is performed after a pre-determined number of packets are received.

14. The method of claim 11, wherein said preventing receipt of additional packets is performed after a pre-determined amount of information is received by the embedded controller.

15. A medium storing instructions adapted to be executed by a processor to perform a method, said method comprising:
transmitting a packet of information from an embedded controller to a network controller; and
preventing additional packets of information from being transmitted for a period of time.

16. The medium of claim 15, wherein said method further comprises:
receiving a packet of network management information; and
preventing additional packets of network management information from being received for a period of time.

17. A method, comprising:
receiving a packet of information; and
preventing additional packets of information from being received by an embedded controller for a period of time.

18. The method of claim 17, wherein said preventing is associated with at least one of: (i) a network controller Rx disable command transmitted from the embedded controller to a network controller, and (ii) a network controller Rx disable strobe.

19. The method of claim 17, wherein said preventing is performed after a pre-determined number of packets are received.

20. The method of claim 17, wherein said preventing is performed after a pre-determined amount of information is received.

21. The method of claim 17, wherein the packets are at least one of: (i) network management information packets, and (ii) total cost of ownership information packets.

22. The method of claim 17, wherein the period of time is a pre-determined duration.

23. A medium storing instructions adapted to be executed by a processor to perform a method, said method comprising:
receiving a packet of information; and
preventing additional packets of information from being received by an embedded controller for a period of time.

24. The medium of claim 23, wherein said preventing is performed after a pre-determined amount of information is received.

25. An apparatus, comprising:
a network controller to exchange information packets with remote devices via a network; and
an embedded controller to exchange information packets with the network controller, wherein the embedded controller is to prevent additional packets from being transmitted to the network controller after transmitting a packet to the network controller.

26. The apparatus of claim 25, wherein the network controller comprises an Ethernet controller that exchange information with the embedded controller via a system management bus interface and further exchanges information with an operating system network stack via a peripheral component interconnect interface.

27. An apparatus, comprising:
a network controller to exchange information packets with remote devices via a network; and
an embedded controller to exchange information packets with the network controller, wherein the embedded controller is to prevent additional packets from being received from the network controller after a packet is received by at least one of: (i) the network controller, and (ii) the embedded controller.

28. The method of claim 27, wherein the embedded controller is to prevent additional packets from being received via at least one of: (i) a network controller Rx disable command transmitted from the embedded controller to the network controller, and (ii) a network controller Rx disable strobe.

29. The apparatus of claim 27, wherein the network controller comprises an Ethernet controller that exchange information with the embedded controller via a system management bus interface and further exchanges information with an operating system network stack via a peripheral component interconnect interface.
